(19) United States
(12) Patent Application Publication
(10) Pub. No.: US 2012/0047449 A1
(43) Pub. Date: Feb. 23, 2012

(54) INTEGRATING A USER BROWSING FEED INTO A CO-BROWSING SESSION

(75) Inventors: Erik John Burckart, Raleigh, NC (US); Andrew Ivory, Wake Forest, NC (US); Barry Joseph Pellas, Durham, NC (US); Matthew Thomas Pellas, Raleigh, NC (US); Matthew Kevin Thomas, Raleigh, NC (US)

(73) Assignee: INTERNATIONAL BUSINESS MACHINES CORPORATION, ARMONK, NY (US)

(21) Appl. No.: 12/857,957

(22) Filed: Aug. 17, 2010

(51) Int. Cl. G06F 3/01

(52) U.S. Cl. 715/753

(57) ABSTRACT

A method for integrating a user browsing feed into a co-browsing session may include allowing a computing device of a user in a co-browsing session to independently navigate a network from each other user in the co-browsing session. The method may also provide an indication of content being viewed by each other user in the co-browsing session on the computing device of the user.

### BACKGROUND

Aspects of the present invention relate to browsing on the Internet or other networks and more particularly to a method, system and computer program product for integrating a user browsing feed into a co-browsing session.

Users in a co-browsing session may browse or navigate the web using independent sessions that can be synchronized to view the same information. However, other users have no indication of what users that are independently browsing may be viewing. When a feature, such as a “follow me” feature is enabled or activated during a co-browsing the session, a master user may send a web page to other users or participants to synchronize what everyone is viewing. If any user leaves the co-browsing session, they lose communication with the other co-browser participants through the co-browsing environment.

### BRIEF SUMMARY

According to one aspect of the present invention, in a co-browsing session a user, as the non-active user, may independently navigate or browse from the co-browsing session using his browser. A browsing feed of the main session including an indication of content being viewed in the main co-browser session may be provided to keep the user inform of what is going on in the main co-browsing session. Additionally, browsing or navigating a web site, Internet or other network by the non-active user or user outside the main co-browsing session may be a feed to other users so that they may be informed of what the other user may be doing or viewing. This co-browsing feature may simulate a real shopping experience of two or more people that took different paths to a checkout counter. Typically when shoppers go into a store, they may proceed some distance together and then go separate directions and then rejoin each other later. The features of the present invention allow online simulation of that experience and keep all parties engaged in the co-browsing session while also allowing users to navigate or browser separately or independently.

According to another aspect of the present invention, a method for integrating a user browsing feed into a co-browsing session may include allowing a computing device of a user in a co-browsing session to independently navigate a network from each other user in the co-browsing session. The method may also provide an indication of content being viewed by each other user in the co-browsing session on the computing device of the user.

According to another aspect of the present invention, a system for integrating a user browsing feed into a co-browsing session may include a processing device. The system may also include a module operating on the processing device for integrating a user browsing feed into a co-browsing session. The module may be adapted to allow the user in a co-browsing session to independently navigate a network from each other user in the co-browsing session. The module may also be adapted to provide an indication of content being viewed by each other user in the co-browsing session.

According to a further aspect of the present invention, a computer program product for integrating a user browsing feed into a co-browsing session may include a computer readable storage medium having computer readable program code embodied therewith. The computer readable program code may include computer readable program code configured to allow a computing device of a user in a co-browsing session to independently navigate a network from each other user in the co-browsing session. The computer readable program code may also include computer readable program code configured to provide an indication of content being viewed by each other user in the co-browsing session on the computing device of the user.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B are a flowchart of an example of a method for integrating a user browsing feed into a co-browsing session in accordance with an embodiment of the present invention.

FIG. 2 is a flowchart of an example of a co-browsing session illustrating integrating a user browsing feed into the co-browsing session in accordance with an embodiment of the present invention.

FIGS. 3A and 3B are each an example of a graphical user interface (GUI) for respective users in a co-browsing session, such as the exemplary co-browsing session illustrated in FIG. 2.

FIG. 4 is a block schematic diagram of an example of a system for integrating a user browsing feed into a co-browsing session in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

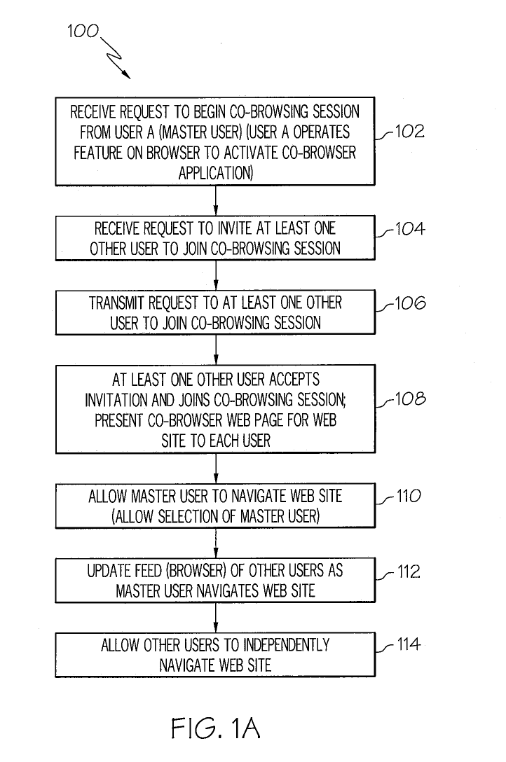

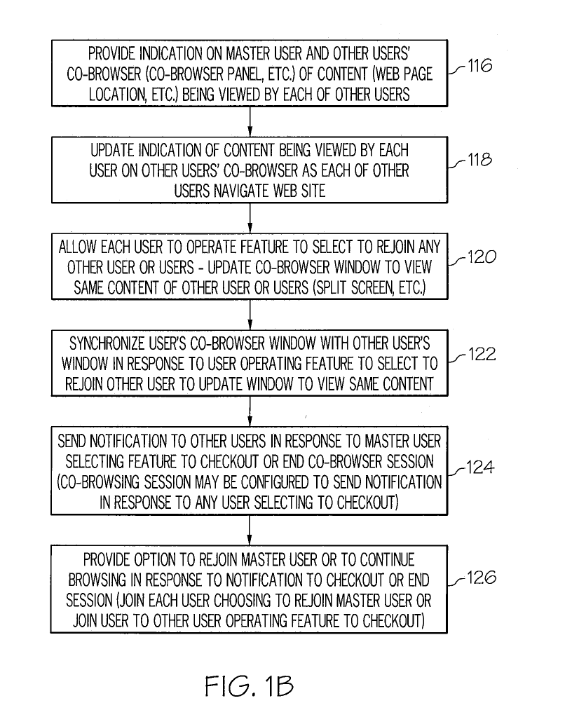

FIGS. 1A and 1B are a flowchart of an example of a method 100 for integrating a user browsing feed into a co-browsing session in accordance with an embodiment of the present invention. In block 102, a request may be received from a user to begin a co-browsing session. The user may activate or operate a feature on a browser to activate the co-browser application, module or feature. The user that activates or initiates the co-browsing session may be designated as the master user or participant.

In block 104, a request may be received to invite at least one other user to join the co-browsing session. The master user may request that an invitation be sent to at least one other user or participant. In block 106, a request or invitation may be sent to at least other user to join the co-browsing session.

In another aspect of the invention, the master user may send invitations by another arrangement, such as by email, text message or other form of communication. The co-browsing session may also be prearranged and scheduled by multiple users or participants for a particular time. Under these scenarios, the different users or participants may request to join a co-browsing session. One of the users may be the master user.

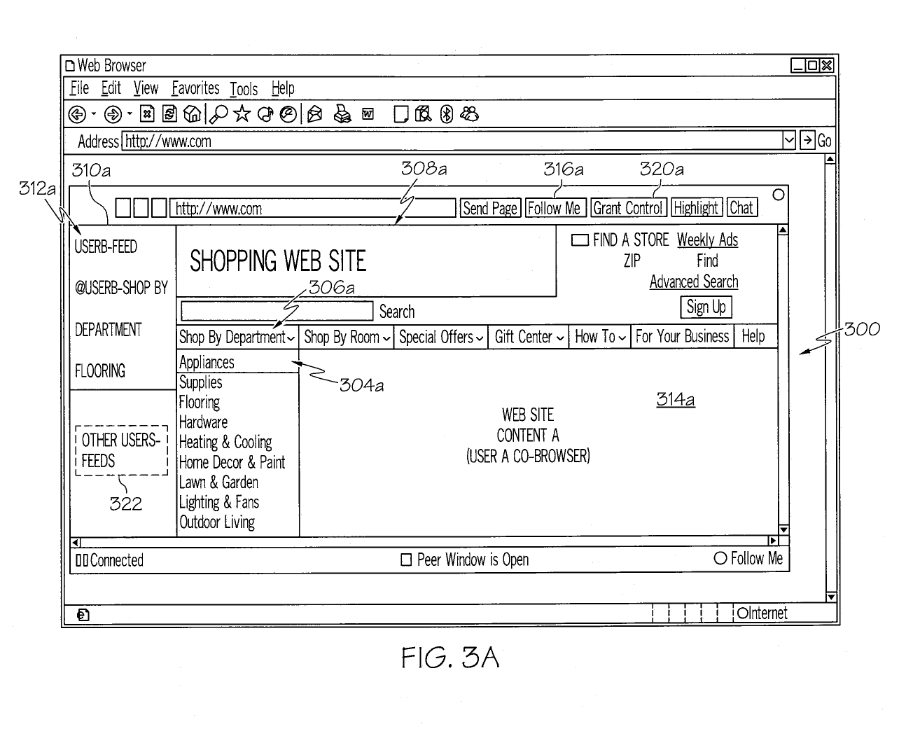

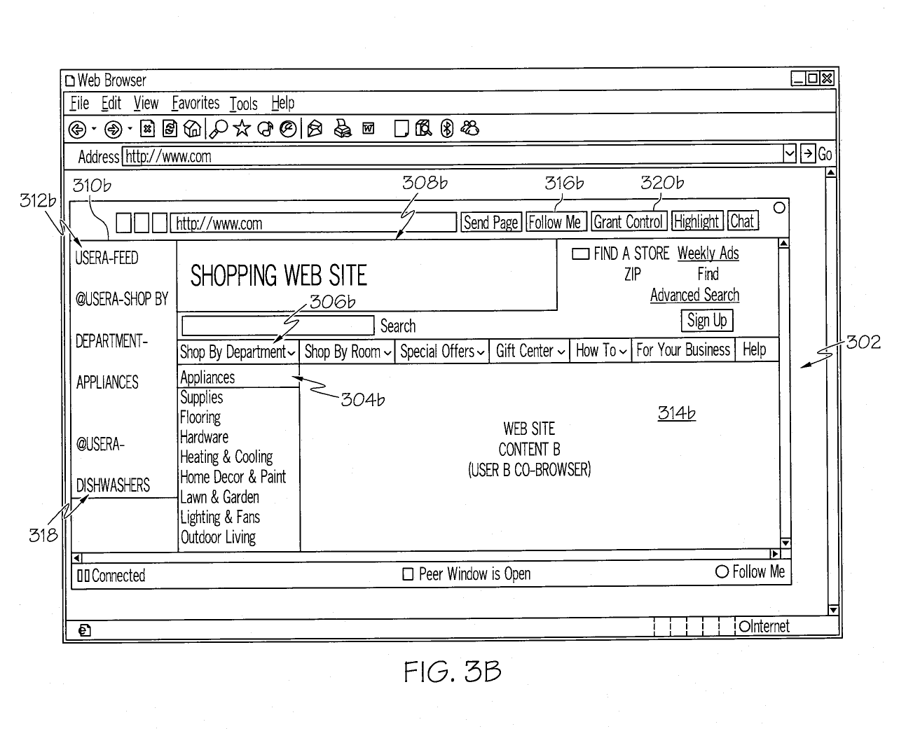

In block 108, at least one other user may accept an invitation to join the co-browsing session or may request to join the co-browsing session. A co-browser web page for a web site may be presented to each user or participant in response to the user or participant joining the co-browsing session. An example of a co-browsing web page including a GUI will be described in more detail with reference to FIGS. 3A and 3B.

In block 110, the master user may be allowed to navigate the web site or Internet. The master user may navigate or browser similar to that which is known in the computing arts, for example, operating links or clicking-on links in a web page using a computer pointing device to access another location on the network or web site.

In block 112, a feed to the browser of other users in the co-browsing session are updated or synchronized as the master user navigates the web site or web. By synchronizing the feed or browser of each user with the master user, each user may view the same content as the master user as the master user browses or navigates using his browser.

In block 114, other users or participants in the co-browser session may be allowed to independently navigate the web site or Internet.

In block 116, an indication may be provided on the master user's browser or co-browser feature of the content being viewed by each of the other users in the co-browser session that may be independently navigating or browsing the web site, Internet or network. Additionally, an indication may also be provided on a browser or co-browser feature of each of the other users in the co-browsing session of the content being viewed by the master user and the content being viewed by each of the other users that may be independently navigating or browsing the web site or Internet. An example of an indication that may be provided of the content being viewed by the master user and other users in a co-browsing session will be described with reference to FIGS. 3A and 3B. For example, a co-browser panel or similar mechanism may be provided on the browser screen or GUI of the user's display for provided the indication of content being viewed. The screen or GUI on a display of a user's computing device may be divided to form the co-browser panel and to form another portion on the screen of the display or GUI to allow independent navigation by the user and to provide content currently being viewed by the user. In another aspect, a separate co-browser panel or window may be provided for each of the other users in the co-browsing session that may be independently navigating the web site or Internet. Each user may be allowed to configure the co-browser panel or panels for providing the content being viewed by each of the other users as each user independently browses or navigates the web site or web.

In block 120, each user may be allowed to operate a feature to select to rejoin or join the master user or any user. The browser window of the rejoining or joining user may be updated or synchronized to provide the same content of the master user or other user. The additional content may be provided on a split a screen or by some other arrangement. In block 122, a user's browser or co-browser may be synchronized with another user's browser or window in response to the user operating the feature to select to rejoin or join the master user or other user to view the same content. For example, a user may rejoin the master user or join another user in the co-browsing session by clicking-on the feed or indication of the content being viewed by the master user or other user in the co-browser panel. A link may be activated in the feed from the master user or other user provided on the computing device of the user desiring to rejoin the master user or to join the other user in viewing the same content. A browser or co-browser of the user may be synchronized with the browser or co-browser of the other user in response to clicking-on the feed from the master user or other user or by operating a link to view the same content as the master user or other user.

In block 124, a notification may be sent to other users or participants in the co-browsing session in response to the master user selecting or operating a feature, icon or menu item to checkout or end the co-browser session. The feature, icon or menu item may be selected or operated using a computer pointing device similar to that known in the computing arts. In another aspect of the invention, a notification may be sent to the other users or participants in the co-browsing session in response to any user or participant in the co-browsing session selecting or operating a feature to checkout.

In block 126, an option may be provided to the users to either rejoin the master user to checkout or end the co-browsing session or to continue browsing or co-browsing. For example, the notification sent in block 124 may include a selectable button or other mechanism that may be operated to rejoin the master user and another selectable button or other mechanism to continue browsing.

In another aspect of the invention, a user may be joined to another user selecting to checkout in response to the user selecting or operating a feature, icon or menu item to join the user that is checking out. For example, the user may operate or click-on the notification that the other user is checking out in order to be joined with the other user. The notification may include a selectable button or other mechanism that may be operated to join the other user and another selectable button or other mechanism to continue browsing.

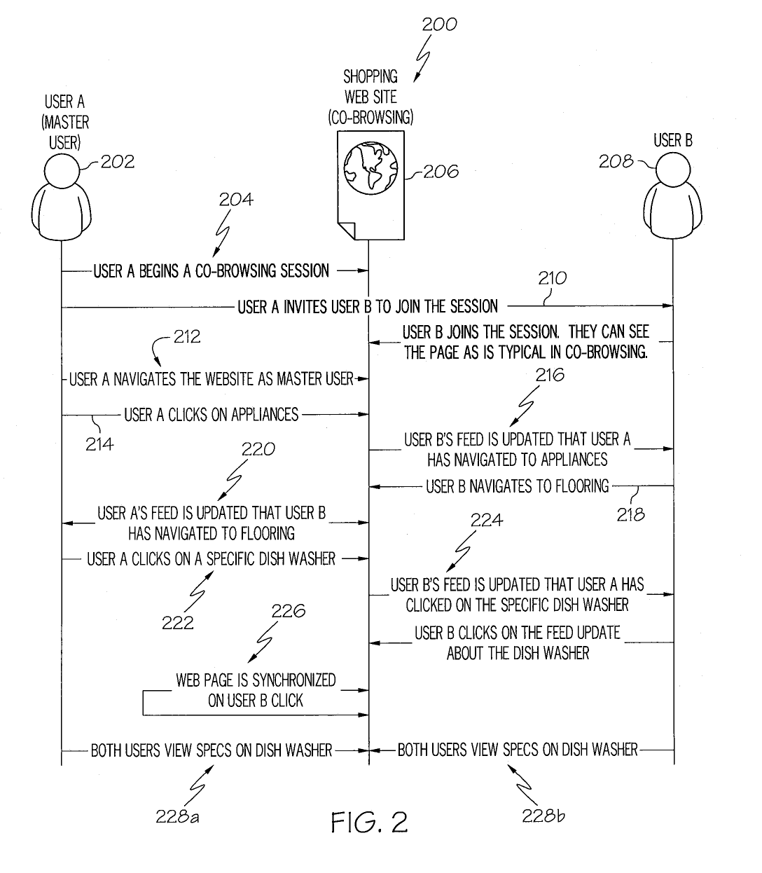

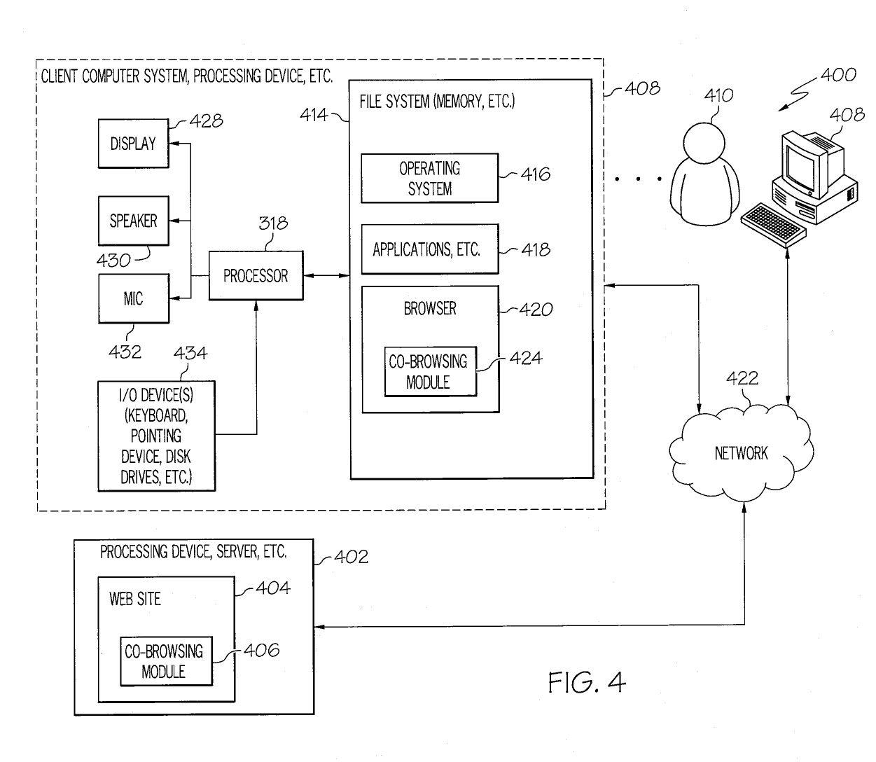

FIG. 2 is a flowchart of an example of a co-browsing session 200 illustrating integrating a user browsing feed into the co-browsing session in accordance with an embodiment of the present invention. The co-browsing session 200 may include or may be performed by the method 100. A user A 202 or master user may begin a browsing or a co-browsing session 204. The co-browsing session 204 may be initiated by user A 202 accessing a shopping web site 206 on a network, such as the Internet, World Wide Web or other network. The user A 202 may access the shopping web site 206 using a computing device, communications device or any other device capable of accessing the shopping web site 206 over a network. An example of a computing device or computer system that may be used to access web sites will be described with reference to FIG. 4.

User A 202 may invite a user B 208 to join the browsing or co-browsing session in operation 210. If user B 208 joins the session, both users 202 and 208 can view the web page as is typical in a co-browsing session. An example of screen shots or GUI's of a master user browser 300 and another user's browser 302 in a co-browsing session will be described with reference to FIGS. 3A and 3B.

In operation 212, user A 202 may navigate the web site as the master user. In operation 214, user A 202 may click-on a link or other feature on the web site 206 to navigate to a particular area of the web site 206. Referring also to FIGS. 3A and 3B, user A 202 may click-on “Appliances” 304a under the menu “Shop by Department” 306a in the shopping web site 308a on user A's browser window 300. In operation 216, user B's feed may be updated that user A 202 has navigated to appliances. Similar to that previously described, an indication may be provided in user B's browser 302 (FIG. 3B) that user A 202 has navigated to a location on the shopping web site 308b, in this example, to appliances 304b. As illustrated in the example of FIG. 3B a co-browsing panel 310b in user B's browser 302 may include a user A feed 312b to provide an indication to user B 208 that user A 202 has navigated to an appliances location 304b on the web site 308b and is likely viewing content related to appliances. If user B 208 is still following user A 202 and has not begun to independently browse or navigate, the content provided by user B's browser 302 in another portion 314b of the screen or GUI of user B's browser 302 may provide the same content being viewed by user A 202 in a similar portion 314a of user A's browser 300. A “Follow Me” feature 316a or tab or similar feature may be operated by the master user or user A 202 for user B 208 to view the same content as user A 202, as user A 202 navigates or browses the shopping web site 206 (FIGS. 2) or 308a and 308b (FIGS. 3A and 3B respectively).

In operation 218 in FIG. 2, user B 208 may navigate to another location on the web site 206. In the example illustrated in FIG. 2 user B has navigated to flooring. In operation 220, user A's feed is updated to provide an indication that user B has navigated to flooring. In FIG. 3A, user A's co-browser panel 310a provides a feed 312a indicating that user B 208 has navigated to flooring. The content being provided in user B's main browser portion 314b may then present content related to flooring.

In operation 222, in the exemplary co-browsing session illustrated in FIG. 2, user A 202 may click-on or navigate to a specific dishwasher. The main browser portion 314a of user B's browser 300 may then present content related to the specific dishwasher. In operation 224 (FIG. 2), User B's feed 312b (FIG. 3B) may then provide an indication 318 that user A 202 has navigated to dishwashers and may be viewing content related to dishwashers.

In operation 226 (FIG. 2), user B 208 may click-on the feed 318 or activate a link associated with the feed 318 to update user B′ browser 302 with the dishwasher content being viewed by user A 202. In operation 226 (FIG. 2), the web site content provided in user B's main browser portion 314b may be synchronized with user A's browser 300 so that user B 208 may view the same content in co-browser portion 314b as user A 202 in user A's co-browser portion 314a. In operations 228a and 228b, both users may view specifications on the dishwasher and other information.

The co-browser GUI 300 and 302 illustrated in the example in FIGS. 3A and 3B may include a “Grant Control” feature 320a and 320b. The “Grant Control” feature 320a may be operated by the master user 202 to allow user B to independently browse or navigate during a co-browsing session.

In accordance with an aspect of the invention, feeds of other users may represented in the co-browser panel 310a and 310b or feeds of other users may each be provided in a separate co-browser panel 322 as illustrated in FIG. 3A. Each user may be allowed to configure the co-browser panel or panels for providing the indication of content being viewed by each of the other users in the co-browsing session.

FIG. 4 is a block schematic diagram of an example of a system 400 for integrating a user browsing feed into a co-browsing session in accordance with an embodiment of the present invention. The method 100 of FIGS. 1A and 1B may be embodied in or performed by the system 400. The operations and features described with reference FIGS. 2 and 3A and 3B may also be embodied in or performed by the system 400. The system 400 may include a processing device 402. The processing device 402 may be a server or similar processing device. The server may host a web site 404, such as a shopping web site or other web site. The processing device 402 or sever may include a co-browsing module 406. The co-browsing module 406 may be embodied in or associated with the web site 404. The co-browsing module 406 may perform some or all of the features and operations described herein with respect to integrating a user browsing feed into a co-browsing session in addition to any other operations that may be associated with providing a co-browsing session.

The system 400 may also include a client computer system 408 usable by an operator or user 410. The client computer system 408 may be any sort of computing device or processing device and may include a communications device such as a mobile or handheld computer or communications device. The method 100 may be embodied in and performed, completely or in part, by the computer system 408 or processing device. The operations and features described with respect to FIGS. 2 and 3A and 3B may also be embodied in and performed, completely or in part, by the computer system 408.

The computer system 408 may include a processor 412 to control operation of the computer system 408 and a file system 414, memory or similar data storage device. An operating system 416, applications 418 and other programs may be stored on the file system 414 for running or operating on the processor 412. A web or Internet browser 420 may also be stored on the file system 414 for accessing the processing device 402 or server via a network 422. The network 422 may be the Internet, an intranet or other private or proprietary network.

A co-browsing module 424 may be embodied in the browser 420 or may a separate module associated with the browser 420. The method 100 described with reference to FIGS. 1A and 1B may be embodied in the module 224. The features and operations described with reference to FIGS. 2 and 3A and 3B may also be embodied in and performed completely or in part by the co-browser module 424. The co-browsing module 424 may perform some or all of the features and operations described herein with respect to integrating a user browsing feed into a co-browsing session in addition to any other operations that may be associated with providing a co-browsing session. System 400 may include only co-browser module 406, only co-browser module 424 or both to perform the operations and provide the features described herein. If both co-browser modules 406 and 424 are provided, the different operations and features described herein may be coordinated between the two modules.

The computer system 408 may also include a display 428, a speaker system 430, and a microphone 432 for voice communications. The computer system 408 may also include one or more input devices, output devices or combination input/output devices, collectively I/O devices 434. The I/O devices 434 may include a keyboard or keypad, pointing device, such as a mouse, disk drives and any other devices to permit a user, such as user 410, to interface with and control operation of the computer system 408.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for integrating a user browsing feed into a co-browsing session, comprising:
allowing a computing device of a user in a co-browsing session to independently navigate a network from each other user in the co-browsing session; and
providing an indication of content being viewed by each other user in the co-browsing session on the computing device of the user.

2. The method of claim 1, wherein providing an indication of the content being viewed by each other user in the co-browsing session comprises providing a co-browser panel on the computing device of the user to display an identification of each other user in the co-browsing session and the indication of the content being viewed by each other user in association with the identification the other user.

3. The method of claim 2, wherein providing a co-browser panel comprises dividing a screen on a display of the computing device to form the co-browser panel and to form another portion on the screen of the display to allow independent navigation by the user and to provide content currently being viewed by the user.

4. The method of claim 3, further comprising providing a separate co-browser panel for each of the other users in the co-browser session the computing device of the user.

5. The method of 4, further comprising allowing configuration of the co-browser panel or panels for providing the indication of content being viewed by each of the other users in the co-browsing session.

6. The method of claim 1, further comprising designating the user initiating the co-browsing session as a master user.

7. The method of claim 6, further comprising allowing the master user to cause synchronization of a web page being viewed by the master user for viewing by each of the other users in the co-browsing session in response to activation of a feature to cause synchronization.

8. The method of claim 1, further comprising allowing one user of the co-browsing session to be selected as a master user.

9. The method of claim 1, further comprising updating a browsing feed from each of the other users in the co-browsing session on the computing device.

10. The method of claim 1, further comprising allowing synchronization with any other user in the co-browsing session to view a same content as the other user by operating a feature associated with the indication of content being viewed by the other user in the co-browsing session using a computer pointing device.

11. The method of claim 1, further comprising allowing synchronization with another user in the co-browsing session to view a same content as the other user by activating a link in a feed from the other user provided on the computing device of the user.

12. The method of claim 1, further comprising providing a notification in response a master user selecting a feature to checkout or end the co-browsing session.

13. The method of claim 12, further comprising providing an option to either rejoin the master user to checkout or end the co-browsing session, or to continue browsing.

14. A system for integrating a user browsing feed into a co-browsing session, comprising:
a processing device; and
a module operating on the processing device for integrating a user browsing feed into a co-browsing session, wherein the module is adapted to allow the user in a co-browsing session to independently navigate a network from each other user in the co-browsing session and to provide an indication of content being viewed by each other user in the co-browsing session.

15. The system of claim 14, further comprising a co-browser panel to display an identification of each other user in the co-browsing session and the indication of the content being viewed by each other user in association with the identification the other user.

16. The system of claim 15, further comprising a module to divide a screen on a display of the computing device to form the co-browser panel and to form another portion on the screen of the display to allow independent navigation by the user and to provide content currently being viewed by the user.

17. The system of claim 14, further comprising a feature to allow synchronization with another user in the co-browsing session to view a same content as the other user by activating a link in a feed from the other user provided on the computing device of the user.

18. A computer program product for integrating a user browsing feed into a co-browsing session, the computer program product comprising:
a computer readable storage medium having computer readable program code embodied therewith, the computer readable program code comprising:
computer readable program code configured to allow a computing device of a user in a co-browsing session to independently navigate a network from each other user in the co-browsing session; and
computer readable program code configured to provide an indication of content being viewed by each other user in the co-browsing session on the computing device of the user.

19. The computer program product of claim 18, wherein the computer readable program code configured to provide an indication of the content being viewed by each other user in the co-browsing session comprises computer readable program code configured to provide a co-browser panel on the computing device of the user to display an identification of each other user in the co-browsing session and the indication of the content being viewed by each other user in association with the identification the other user.

20. The computer program product of claim 18, further comprising computer program product code configured to allow synchronization with another user in the co-browsing session to view a same content as the other user by activating a link in a feed from the other user provided on the computing device of the user.
